(19) United States
(12) Patent Application Publication
(10) Pub. No.: US 2006/0282601 A1
(43) Pub. Date: Dec. 14, 2006

(54) Information processing apparatus and power-saving controlling method

(75) Inventor: Katsuhiro Uchida, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/443,339

(22) Filed: May 31, 2006

(30) Foreign Application Priority Data
May 31, 2005 (JP) 2005-160615

(51) Int. Cl. G06F 13/36; G06F 1/32

(52) U.S. Cl. 710/309; 713/320

(57) ABSTRACT

According to one embodiment, an information processing apparatus includes a first bridge circuit which communicates with a processor and a storage section, a second bridge circuit which communicates with the first bridge circuit, an external bus control section which communicates with the second bridge circuit and which uses one of a plurality of transfer modes including an isochronous transfer mode to communicate with an external apparatus for data transfer between the external apparatus and the storage section, and a power saving setting section which, when the processor is in an idling state, sets a power saving mode which avoids disabling the communication between the first bridge circuit and the second bridge circuit so as to transfer the data between the external apparatus and the storage section if the isochronous transfer mode is being used for the data transfer between the external bus control section and the external connection apparatus.

### CROSS-REFERENCE TO RELATED APPLICATIONS

This application is based upon and claims the benefit of priority from Japanese Patent Application No. 2005-160615, filed May 31, 2005, the entire contents of which are incorporated herein by reference.

### BACKGROUND

1. Field

One embodiment of the invention relates to an information processing apparatus having a power saving mechanism as well as a power-saving controlling method.

2. Description of the Related Art

In recent years, various computers have been developed, for example, portable notebook or sub-notebook type personal computers and pocket computers such as portable information terminals.

Some of these personal computers comprise an IEEE 1394 port or a USB port as an interface for connections with external apparatuses. To execute communication using the IEEE 1394 port or USB port, one of the following modes is used: an isochronous transfer mode (real-time transfer mode) and an asynchronous transfer mode (non-real-time transfer mode), control transfer (non-real-time transfer mode), bulk transfer (non-real-time transfer mode), and interrupt transfer (non-real-time transfer mode). An expansion hard disk drive, a digital video camera, or the like is connected to the IEEE 1394 port or USB port. If a digital video camera is connected to the port, the isochronous transfer mode is often used for communications.

These portable personal computers are provided with various power saving functions for saving power used for the computer system, so as to be drivable by batteries for a longer time.

Upon detecting a system idle state on the basis of a factor such as the lack of a task to be executed, an operating system OS calls an idle instruction to notify a control program such as a system BIOS of the system idle state. Upon reception of notification of the system idle state, the system BIOS stops a CPU or lowers its operating speed to switch the system state from a normal operation mode to a power saving mode requiring less power than the normal operation mode. If an event such as an interruption signal from any device occurs in the power saving mode, the system state correspondingly returns to the normal operation mode.

The above isochronous transfer mode is based on a data transfer scheme ensuring that one packet of data is transmitted every 125 μs. However, setting the power saving mode may disable real-time data transfers depending on the data size of a transferred packet. This may result in the loss of frames or sound from motion pictures or sound data transferred to the digital video camera.

Jpn. Pat. Appln. KOKAI Publication No. 2000-32081 discloses a method of prohibiting a shift to the power saving mode during communications with an external apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram showing a notebook type personal computer implemented as an information processing apparatus in accordance with an embodiment of the present invention and a video camera implemented as an external apparatus;

FIG. 2 is a block diagram showing the notebook type personal computer implemented as an information processing apparatus in accordance with the embodiment of the present invention and the video camera implemented as an external apparatus;

FIG. 3 is a block diagram showing an ACPI and IEEE 1394 functions in the notebook type personal computer as an information processing apparatus in accordance with the embodiment of the present invention, as well as the video camera; and

FIG. 4 is a flowchart illustrating a process executed to shift to a CPU idling state in accordance with the embodiment of the present invention.

### DETAILED DESCRIPTION

Various embodiments according to the invention will be described hereinafter with reference to the accompanying drawings. In general, according to one embodiment of the invention, an information processing apparatus comprises a processor, a storage section, a first bridge circuit which communicates with the processor and the storage section, a second bridge circuit which communicates with the first bridge circuit, an external bus control section which communicates with the second bridge circuit and which uses one of a plurality of transfer modes including an isochronous transfer mode to communicate with an external apparatus for data transfer between the external apparatus and the storage section; and, a power saving setting section which, when the processor is in an idling state, sets a power saving mode which avoids disabling the communication between the first bridge circuit and the second bridge circuit so as to transfer the data between the external apparatus and the storage section if the isochronous transfer mode is being used for the data transfer between the external bus control section and the external connection apparatus.

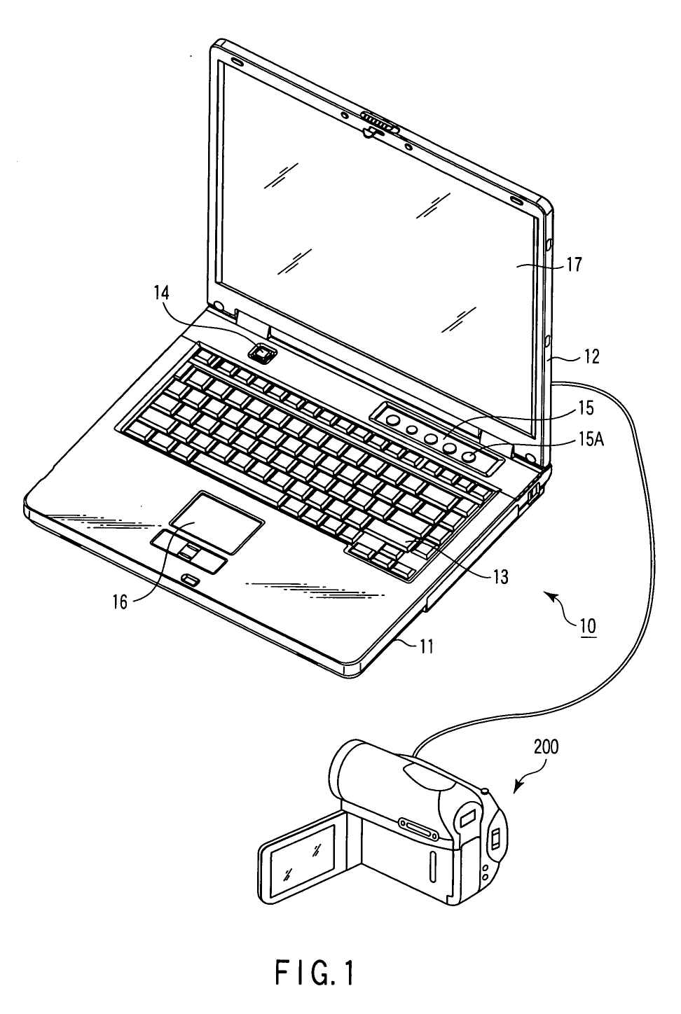

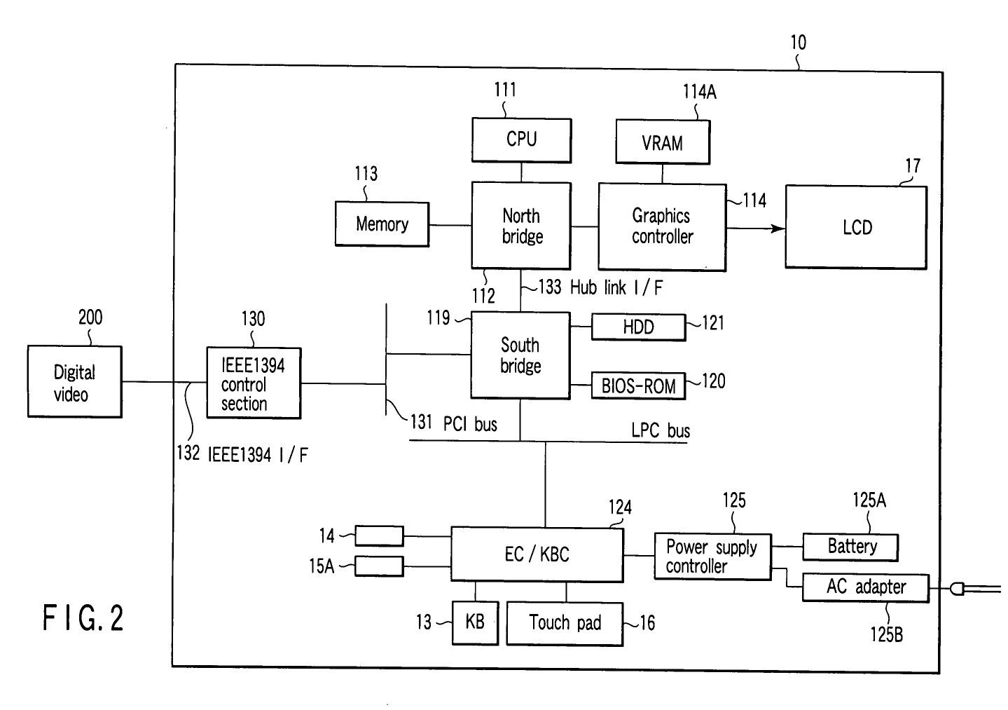

First, with reference to FIGS. 1 and 2, description will be given of an information processing apparatus in accordance with an embodiment of the present invention. This information processing apparatus is implemented as a portable notebook type personal computer 10. A digital video camera 200 is connected to the personal computer 10 via an external connection port.

FIG. 1 is a perspective view in which a display unit of the notebook personal computer 10 is open. The computer 10 is composed of a computer main body 11 and a display unit 12. The display unit 12 incorporates a display panel composed of a liquid crystal display (LCD) 17 and a backlight. A display screen of the LCD 17 is placed almost in the middle of the display unit 12. The LCD 17 is composed of a transmissive liquid crystal panel. In the display unit 12, the backlight is placed on a rear surface of the LCD 17. The backlight functions as an illumination device for the display unit 12.

The display unit 12 is supported by a computer main body 11. The display unit 12 is attached to the computer main body 11 so as to be rotatively movable between an open position where the display unit 12 is open to expose a top surface of the computer main body 11 and a closed position where the display unit 12 is closed to cover the top surface of the computer main body 11. The computer main body 11 has a housing shaped like a thin box. The computer main body 11 has a keyboard 13, a power button 14, an input operation panel 15, and a touch pad 16, and the like arranged on its top surface; the power button 14 is used to turn on and off a power supply to the computer 10.

The input operation panel 15 is an input device that inputs an event corresponding to a depressed button. The input operation panel 15 comprises a plurality of buttons that activates the respective functions.

Now, the system configuration of the computer 10 will be described with reference to FIG. 2.

As shown in FIG. 2, the computer 10 comprises a CPU (processor) 111, a north bridge 112, a main memory (first storage section) 113, a graphics controller 114, a south bridge 119, BIOS-ROM 120, a hard disk drive (HDD) (second storage section) 121, an embedded controller/keyboard controller IC (EC/KBC) 124, and a power supply controller 125.

The CPU 111 is a processor that controls operations of the computer 10. The CPU 111 executes the operating system (OS) and various application programs loaded from the hard disk drive (HDD) 121 to the main memory 113.

The CPU 111 also executes Basic Input Output System (BIOS) stored in BIOS-ROM 120. BIOS is a program for controlling hardware.

A north bridge 112 is a bridge device that connects a local bus in the CPU 111 and a south bridge 119 together. The north bridge 112 and the south bridge are connected together via a HUB link interface 133. The north bridge 112 incorporates a memory controller that controls accesses to the main memory 113. The north bridge 112 also has a function for communicating with a graphics controller 114 via an Accelerated Graphics Port (AGP).

The graphics controller 114 is a display controller that controls the LCD 17, used as a display monitor for the computer 10. The graphics controller 114 has a video memory (VRAM) 114A to generate a video signal from display data written to the video memory 114A by the OS or application program; the video signal is to be displayed on the LCD 17 of the display unit 12.

The south bridge 119 controls each of the devices on an Low Pin Count (LPC) bus. The south bridge 119 also has a built-in Integrated Drive Electronics (IDE) controller that controls the HDD 121. The south bridge 119 further has a function for controlling accesses to BIOS-ROM 120. An IEEE 1394 control section 130 is connected to the south bridge 119 via a PCI bus to serve as an interface device for data communications with an external apparatus. The digital video camera 200 is connected to the IEEE 1394 control section 130 via an IEEE 1394 interface 132. The communication between the south bridge 119 and the IEEE 1394 control section 130 is based on either an isochronous transfer mode (real-time transfer mode) or an asynchronous transfer mode (non-real-time transfer mode).

The HDD 121 is a storage device in which various software and data are stored. The above operating system and various application systems are stored in the HDD 121.

The embedded controller/keyboard controller IC (EC/KBC) 124 is a one chip microcomputer into which an embedded controller and a keyboard controller are integrated; the embedded controller manages power and the keyboard controller controls the keyboard (KB) 13 and the touch pad 16. The embedded controller/keyboard controller IC (EC/KBC) 124 has a function of cooperating with the power supply controller 125 in powering on and off the computer 10 in response to a user's operation of the power button 14.

The computer 10 is equipped with the operating system 140 manufactured by Microsoft and having a system power saving function called Advanced Configuration and Power Interface (ACPI). The ACPI function is effective not only on what is called notebook type personal computer equipped with batteries, in terms of battery driving time but also on what is called desktop type personal computers equipped with no batteries, in terms of a reduction in the power consumption of an AC power source, temperature control, and the like.

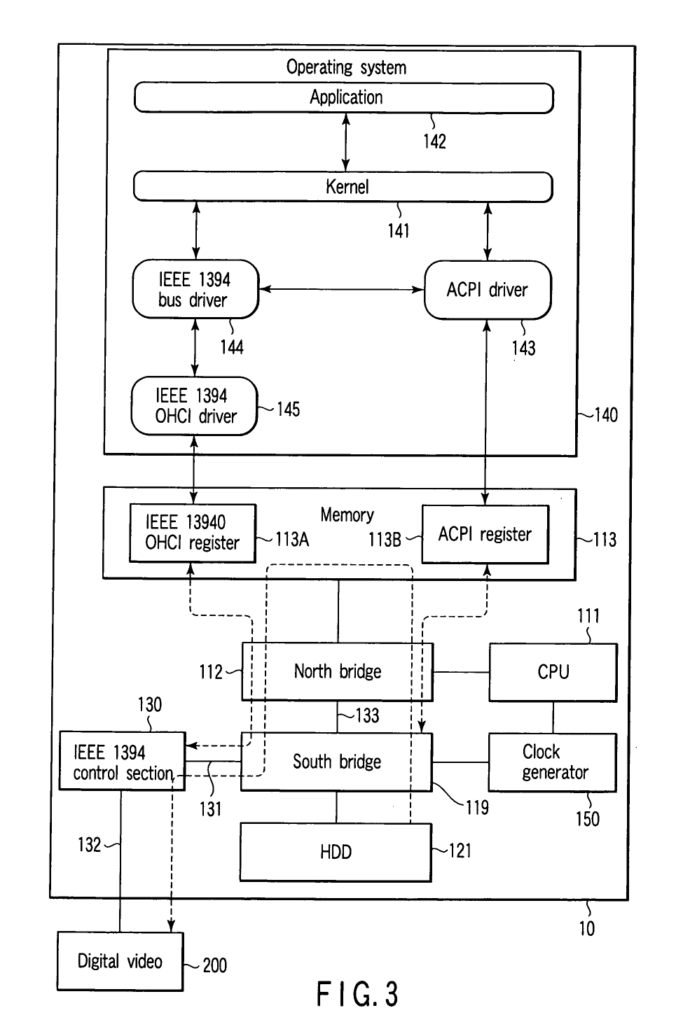

FIG. 3 is a block diagram showing the ACPI and IEEE 1394 function in the personal computer as the information processing apparatus in accordance with the embodiment of the present invention.

The digital video camera 200 has a function for recording and editing images and sound. The digital video camera 200 can be connected to the personal computer 10 via the IEEE 1394 interface 132.

Motion pictures and sound data are transferred in real time between the personal computer 10 and the digital video camera 200 via the IEEE 1394 interface 132. The real-time transfer is based on a data transfer scheme which is called the isochronous transfer mode and which ensures that one data packet is transmitted every 125 μs.

It is assumed that motion picture data in the personal computer 10 is to be transferred to the digital video camera 200.

If data is transferred between the digital video camera 200 and the IEEE 1394 control section 130 in the isochronous transfer mode, an IEEE 1394 1384 OHCI driver 145 sets an isochronous transmission and reception bits in an interruption event (IntEvent) register in an IEEE 1394 Open Host Controller Interface (OHCI) register 113A.

The motion picture data about to be transmitted is transferred, by an application 142 on the operating system 140, from the storage device such as the hard disk drive (HDD) 121, to which the data has been saved, to the memory 113. The data is then stored in the memory 113. To acquire motion picture data, the IEEE 1394 control section 130 transmits a memory read request to the south bridge 119 via the PCI bus 131. The PCI device such as the IEEE 1394 control section 130 thus issues a request on the PCI bus 131 to access the memory 111 or I/O and is called a bus master. Upon reception of the request, the south bridge 119 acquires the data stored in the memory 113 via the north bridge 112. The south bridge 119 then transfers the data to the IEEE 1394 control section 130 via the PCI bus 131. The IEEE 1394 control section 130 uses the isochronous transfer scheme to transmit one packet of data to the digital video camera 200 via the IEEE 1394 control section 130 every 125 μs.

One of the ACPI functions of the personal computer 10 is a function for controlling the CPU 111 which is called a processor power state. With this function in operation, CPU 111 in the personal computer mainly exhibits the following three states.

C0 state: CPU 111 is operating normally.

C2 state: an external clock is supplied to CPU 111 but is stopped inside the CPU 111, thus enabling accesses to a cache.

C3 state: No external clock is supplied to CPU 111, thus disabling accesses to the cache. In the C3 state, a function of controlling the HUB link interface 133 between the south and north bridges 119 and 112 is disabled. This increases the time required to return to the C0 state.

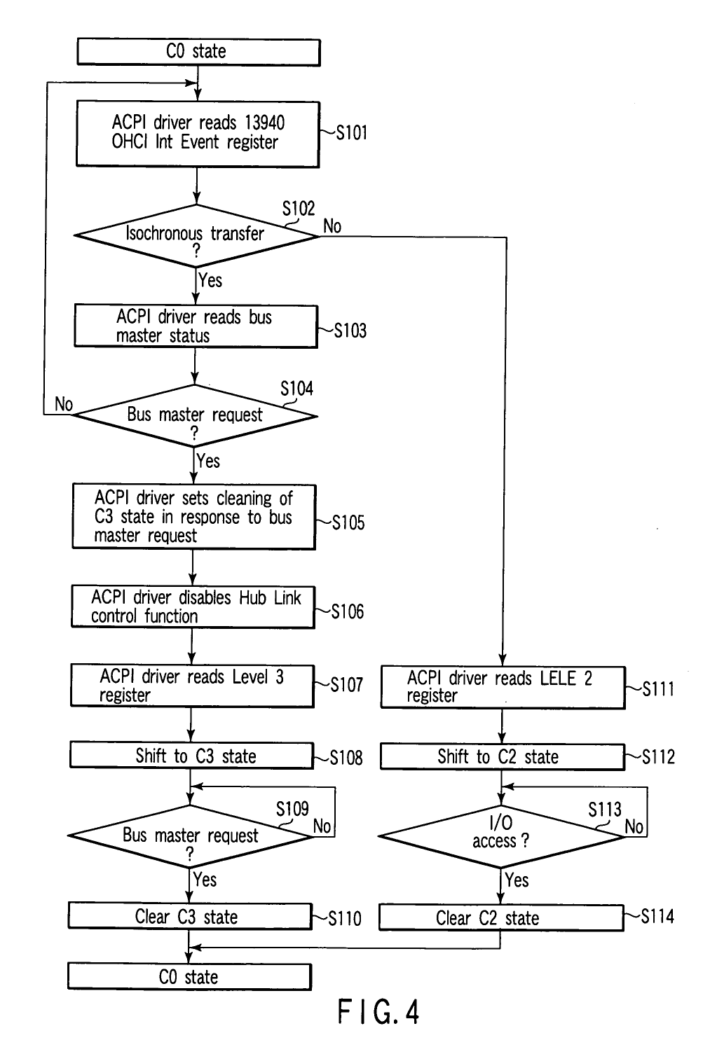

In the C2 and C3 states, CPU 111 is set to the power saving mode. The time to set the CPU to the power saving mode will be described with reference to the flowchart in FIG. 4.

It is assumed that the processor power state is C0. An ACPI driver 143 in the operating system 140 accesses the IEEE 1394 OHCI register 113A in the memory 113 via a kernel 141, an IEEE 1394 bus driver 144, a 1394 Open Host Controller Interface (OHCI) driver 145 (block S101). The ACPI driver 143 checks an isochronous transmission/reception bit in the interruption event (IntEvent) register in the IEEE 1394 OHCI register 113A to determine whether or not the isochronous transfer mode is being used to transfer data between the IEEE 1394 control section 130 and the digital video camera 200 (block S102). If the isochronous transmission/reception bit in the IntEvent register in the IEEE 1394 OHCI register 113A is not set and thus the isochronous transfer mode is not in use (No in block S102), the ACPI driver 143 accesses the ACPI register 113B in the memory 113, managed by the south bridge 119 (block S103), to determine whether or not the PCI device connected to the PCI bus 131 for the IEEE 1394 control section 130 and the like is making a request on the PCI bus, that is, whether or nor a bus master request is being made (block S104).

If a bus master request is being made (No in block S104), blocks S101 to S104 are executed again about 10 ms later. If no bus master request is being made (Yes in block S104), the ACPI driver 143 accesses the ACPI register 113B to execute a series of C3 state shifting processes.

First, the ACPI driver 143 writes settings to the ACPI register 113B such that the next bus master request returns from the C3 state to the C0 state (block S105). Then, the ACPI driver 143 disables the function of controlling the HUB link interface 133 between the south bridge 119 and the north bridge 112 (block S106). Finally, the ACPI driver 143 reads a Level 3 register in the ACPI register (block S107) to shift the processor power state to C3 (block S108). To allow the processor power state to C3, a SPUSTP# signal supplied to a clock generator 150 by the south bridge 119 is enabled, thus stopping the supply of clocks from the clock generator 150 to CPU 111.

After the shift to the C3 state, the south bridge 119 accesses the ACPI register 113B to determine

whether or nor a bus master request is being made (block S109). If no bus master request is being made (No in block S109), the south bridge 119 checks for a bus master request again a predetermined time later.

If a bus master request is being made (Yes in block S109), the south bridge 119 reads in the ACPI register 113B to return the processor power state from C3 to C0 (block S110). When the C3 state changes to the C0 state, the processor power state first changes to C2 and then to C0 (block S111). This enables the PCI device to execute a bus master access.

In block S102, if the isochronous transfer mode is in use (Yes in block S102), the ACPI driver reads in a Level 2 register (block S121) to shift the processor power state to C2 (block S122). In the C2 state, a STPCLK# signal supplied to CPU 111 by the south bridge 119 is enabled. A clock signal is thus supplied to CPU 111 by the clock generator 150 but is stopped inside the CPU 111. However, the cache memory in CPU 111 keeps on operating.

In the C2 state, the function of controlling the interface 133 between the south bridge 119 and the north bridge 112 is not disabled. Accordingly, the cache in CPU 111 can be accessed, thus enabling a bus mater access.

In the C2 state, the ACPI driver checks every predetermined period of time whether or not an I/O access has been made, resulting in the need to execute a process for CPU 111 (block S113). If an I/O access has been made (Yes in block S113), the C2 state is cleared (block S114) to return the processor power state to C0.

After the C3 state is cleared, at least about 100 μs may be required to return to the C0 state. Since the isochronous transfer with the IEEE 1394 interface is specified to transfer one packet every 125 μs, the PCI bus can use only a short active time within one cycle (125 μs). This may disable real-time data transfers depending on the data size of a packet transferred. As a result, frames or sound may be lost from motion picture or sound data transferred to the digital video camera 200. In the present embodiment, the ACPI driver checks in block S102 whether or not the isochronous transfer mode is being used to transfer data between the digital video camera 200 and the IEEE 1394 control section 130. If the isochronous transfer mode is being used to transfer data, the C2 state is set to enable accesses to the memory 113. Real-time data transfers can therefore be executed.

In the description of the above example, the IEEE 1394 interface connects the external apparatus and the external connection bus control section together. However, a Universal Serial Bus (USB) interface may connect the external apparatus and the external connection bus control section together. With USB, one of the following transfer modes is used to communicate data: isochronous transfer mode (real-time transfer mode) and asynchronous transfer mode (non-real-time transfer mode), control transfer (non-real-time transfer mode), bulk transfer (non-real-time transfer mode), and interrupt transfer (non-real-time transfer mode).

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processor;
a storage section;
a first bridge circuit which communicates with the processor and the storage section;
a second bridge circuit which communicates with the first bridge circuit;
an external bus control section which communicates with the second bridge circuit and which uses one of a plurality of transfer modes including an isochronous transfer mode to communicate with an external apparatus for data transfer between the external apparatus and the storage section; and
a power saving setting section which, when the processor is in an idling state, sets a power saving mode which avoids disabling the communication between the first bridge circuit and the second bridge circuit so as to transfer the data between the external apparatus and the storage section if the isochronous transfer mode is being used for the data transfer between the external bus control section and the external connection apparatus.

2. The information processing apparatus according to claim 1, wherein in the power saving mode, a clock is supplied to the processor but is stopped inside the processor.

3. The information processing apparatus according to claim 1, wherein either IEEE 1394 or Universal Serial Bus is used to connect the external apparatus and the external bus control section together.

4. The information processing apparatus according to claim 1, wherein the external bus control section writes information indicating whether or not the isochronous transfer mode is in use, to the storage section, and
the power saving setting section reads the information to recognize that the isochronous transfer mode is being used for the data transfer.

5. The information processing apparatus according to claim 1, wherein a PCI bus connects the second bridge circuit and the external bus control section together.

6. A power-saving controlling method for an information processing apparatus comprising a processor, a storage section, a first bridge circuit which communicates with the processor and the storage section, a second bridge circuit which communicates with the first bridge circuit, and an external bus control section which communicates with the second bridge circuit and which uses one of a plurality of transfer modes including an isochronous transfer mode to communicate with an external apparatus for data transfer between the external apparatus and the storage section, the method comprising:
if the processor is in an idling state, determining whether or not the isochronous transfer mode is being used for the data transfer between the external bus control section and the external connection apparatus so as to transfer data between the external apparatus and the storage section; and
if the isochronous transfer mode is being used for the data transfer between the external bus control section and the external connection apparatus, setting a power saving mode which avoids disabling the communication between the first bridge circuit and the second bridge circuit.

7. The power-saving controlling method according to claim 6, wherein in the power saving mode, a clock is supplied to the processor but is stopped inside the processor.

8. The power-saving control method according to claim 6, wherein either IEEE 1394 or USB is used to connect the external apparatus and the external bus control section together.

9. The power-saving control method according to claim 6, further comprising a step of writing information indicating whether or not the isochronous transfer mode is in use, to the storage section, and
the determination is made by reading the information.

10. The power-saving control method according to claim 6, wherein a PCI bus connects the second bridge circuit and the external bus control section together.
